(19) United States
(12) Patent Application Publication
(10) Pub. No.: US 2017/0000684 A1
(43) Pub. Date: Jan. 5, 2017

(54) MULTIFUNCTIONAL PHYSIOTHERAPY DEVICE AND PHYSIOTHERAPY METHOD

(71) Applicant: Runjing Huang, Dongguan (CN)

(72) Inventor: Zhuohong Huang, Dongguan (CN)

(21) Appl. No.: 15/265,853

(22) Filed: Sep. 15, 2016

Related U.S. Application Data
(63) Continuation of application No. PCT/CN2015/073672, filed on Mar. 5, 2015.

(30) Foreign Application Priority Data
Mar. 21, 2014 (CN) 201410107443.0

(51) Int. Cl. A61H 7/00

(52) U.S. Cl. CPC A61H 7/003; A61H 7/007; A61H 2201/1253; A61H 2201/01

(57) ABSTRACT

A multifunctional physiotherapy device includes an elastic support assembly, a physiotherapy assembly, a housing assembly, a sleeve casing and an imaging assembly. The housing assembly is disposed on the outside of the elastic support assembly, the physiotherapy assembly is removably secured on the elastic support assembly. The sleeve casing is disposed at the joint of the physiotherapy assembly and the elastic support assembly. A user holds the housing assembly to direct the physiotherapy assembly in the physiotherapy area and moves it back and forth to complete the therapy, and the physiotherapy actions are observed through the imaging assembly. The physiotherapy assembly includes a massage head, a scraping head and a moxibustion head that can be removably secured on the elastic support assembly, sequentially completing massage, scraping and moxibustion physiotherapy actions respectively. The multifunctional physiotherapy device has a simple structure and a clever design with remarkable physiotherapy effects.

### FIELD OF THE DISCLOSURE

The disclosure relates to a health care facility, and more particularly to a multifunctional physiotherapy device and a physiotherapy method.

### BACKGROUND OF THE DISCLOSURE

Massage has functions of promoting local blood circulation and metabolism to relax human body after whole day work and eliminate fatigue so as to achieve a certain workout effect, especially to students, white collar workers, staffs working on computers for long time, managers, IT practitioners, ones who work under high pressure, myopic people, patients suffer insomnia occasionally, senior citizens, guys with athletic injury, people suffering varicosity, whose legs are swollen and pain, numbness with poor blood circulation, hypoimmunity ones, etc., the multifunctional physiotherapy device and the physiotherapy method have significant effects upon them.

Scraping has effects such as promoting blood circulation, dissipating blood stasis, and relaxing muscles, which is applied in internal medicine, surgery, department of gynaecology and paediatrics for multiple diseases as well as cosmetic and healthcare fields, especially in recovery of painful diseases and osteoarthropathy degenerative diseases such as cervical spondylosis and periarthritis. Clinical treatments for respiratory diseases such as cold, fever and cough can be combined with cupping. Treatments for skin diseases such as acne and chloasma can be combined to acupuncture and moxibustion with blood-letting puncture. Subhealth and other diseases such as chronic fatigue syndrome can be prevented and treated as well. At present, the scraping generally adopts a scraping board, a manner for scraping is that a patient lies down and another one holds the scraping board to scrape the patient, the entire process needs to be done with two people, and strength for scraping is difficult to control, skin can be destroyed under high pressure.

Moxibustion physiotherapy is a vital component of traditional Chinese medicine. The moxibustion physiotherapy is abbreviated as moxibustion. A burning moxa cone or moxa stick made of moxa or blended with other medicine can be aligned or disposed on a certain surface of a body or acupuncture point and transmitted by meridian to go deep into bowels for warming meridian, regulating blood, strengthening the body to eliminate pathogenic factors, adjusting physiological functions, enhancing immunity, so as to prevent diseases and cure diseases and keep health. The initial moxibustion physiotherapy is holding a burning moxa stick and approaching a section in need for physiotherapy of the body, a physiotherapy effect can be achieved by interval heating, but according to the manner, a distance between the moxa stick and the body is difficult to be controlled, which can cause burning on skin, and ashes of burning the moxa stick are hard to deal with. A moxibustion box can diminish the flaws above to some extent, which is burning the moxibustion stick in the moxibustion box, then heating the body through the moxibustion box, ashes generated by inflammation fall in the moxibustioin box for collection, such as Chinese patent application No. 201220053792.5 entitled “Moxibustion box” discloses the moxibustion box to iron moxibustion for physiotherapy, which can prevent the burning moxibustion from hurting skin, but its moxibustion effect is poorer than direct moxibustion due to interval of the box, it takes longer time to achieve an identical effect, and assistance of another person is necessary in physiotherapy of sections such as the back.

Chinese patent application No. 201410052231.7 applied by the applicant that entitled “Massage device” filed on Feb. 17, 2014 solves shortcomings in a conventional massage device: a, the massage part is fixed, only a certain part of the body such as the back can be massaged, massage accuracy is low and belonging to covering massage, accurate massage on a certain part for a long time can hardly be achieved; b, it is inconvenient to carry, power supply is a must for operation so that outdoor work cannot be satisfied; c, power consumption and costs are considerable; d, strength for massage is small; e, massage parts are exposed without protection, massage cannot rely on an external force so that instability and vibration can occur; f, massage can be applied on limited parts of the body, only certain parts can be massaged, etc. But the function of the massage device is unitary, the massage effect can merely be enforced in physical aspects, which will take a long time and high strength to massage, highly demanding for physical strength of a massage therapist.

### SUMMARY OF THE DISCLOSURE

Aiming at shortcomings of the conventional technique above, the disclosure provides a simply structural, ingeniously designed, multifunctional physiotherapy device combined physics and medicine controlled by a single person.

Embodiments of the disclosure are as follows. A multifunctional physiotherapy device includes an elastic support assembly, a physiotherapy assembly, a housing assembly, a sleeve casing and an imaging assembly. The housing assembly wraps the elastic support assembly, the physiotherapy assembly is detachably secured on the elastic support assembly. The sleeve casing is disposed at a joint of the physiotherapy assembly and the elastic support assembly. A user holds the housing assembly to direct the physiotherapy assembly in a physiotherapy area and moves it back and forth to complete the therapy, and observes the physiotherapy actions through the imaging assembly. The physiotherapy assembly includes a massage head, a scraping head and a moxibustion head, the massage head, the scraping head and the moxibustion head are all detachably secured on the elastic support assembly for completing massage, scraping and moxibustion physiotherapy actions respectively.

Preferably, the elastic support assembly includes a first handle, a second handle and a connecting plate. The first handle and the second handle are flexible handles, internal ends of which are secured on two ends of the connecting plate respectively. Two sides of the connecting plate are disposed with positioning bars whose diameter is in a range of 4-20 mm, the positioning bars play a positioning role during physiotherapy or pat and massage directly.

Preferably, the housing assembly includes a first handle cover, a second handle cover and spacer rings. The first handle cover and the second handle cover are flexible handle covers disposed out of the first handle and the second handle respectively. At least two spacer rings are wrapping the first handle cover and the second handle cover separately, the spacer rings divide the first handle cover and the second handle cover into at least two sections longitudinally. The sections are handle sections, the handle sections of different distances are for various massage parts.

Preferably, the sleeve casing wraps the connecting plate and the positioning bars for providing buffer during pat and massage. A bottom of the sleeve casing is an enclosed flat surface for bearing stress, preventing slip and protecting a surface of a pressed objective. A top and two ends of the sleeve casing are open, the physiotherapy assembly extends through the top of the sleeve casing, the first handle cover and the second handle cover extend through the two ends of the sleeve casing respectively, external surfaces of which and an internal surface of the sleeve casing are interference connected.

Preferably, thicknesses of the first handle and the second handle are 0.3-2.5 mm, widths of which are 15-45 mm, material is flaky elastic material. Holes with a diameter in a range of 6-12 mm are defined in two ends of the first handle and the second handle respectively for hanging and packaging.

Preferably, a mesh plate is disposed in the moxibustion head to collect ashes after burning a moxa stick. A bottom of the moxibustion head is secured with a moxa stick clamp, a clamp opening of the moxa stick clamp clips a moxibustion stick for fixing and positioning. The moxibustion stick is pushed towards the moxibustion head by releasing the clamp opening after burning the moxibustion stick for a while.

Preferably, a moxa stick push assembly is inserted in a tail of the moxibustion stick. The moxa stick push assembly includes a push pin and a push pin seat, the push pin is inserted in the tail of the moxibustion stick. The push pin seat is pushed forward for burning the remaining moxibustion stick when the moxibustion stick is about to be burnt out.

Preferably, the physiotherapy assembly further includes a connecting seat, the connecting seat is secured on the connecting plate. The massage head, the scraping head and the moxibustion head are detachably secured on the connecting seat. A through-hole is defined in the middle of the connecting seat, a blocking plate is disposed in the through-hole adjacently to its upper end, a positioning groove and at least two moxa stick holes are defined in the blocking plate, the scraping head is embedded in the positioning groove for positioning, one or at least two moxibustion sticks are inserted in the moxa stick holes for fixing. Connecting holes are defined in two sides of the connecting seat, connecting holes are further defined in the massage head, the scraping head and the moxibustion head correspondingly, the massage head, the scraping head and the moxibustion head are embedded in a top of the connecting seat respectively, a connecting rod is inserted in the connecting holes of connecting seat, the massage head, the scraping head and the moxibustion head respectively and detachably securing the massage head, the scraping head and the moxibustion head on the connecting seat respectively.

Preferably, the imaging assembly has a wireless connection module to connect the imaging assembly and an external electric display device wirelessly, and display physiotherapy actions by the external electric display device, the electric display device can be a smart phone, a PDA, a tablet, a laptop, etc. Moreover, the wireless connection module is a wireless Bluetooth module or a wireless WIFI module.

A physiotherapy method utilizing the multifunctional physiotherapy device above includes following steps:

a, assembling: first, placing the first handle and the second handle in the first handle cover and the second handle cover respectively, second, covering the sleeve casing on outsides of the first handle cover, the second handle cover and the connecting plate, finally, securing the connecting seat on the connecting plate;

b, massage: embedding the massage head in the top of the connecting seat, fixing and positioning by the connecting rod, a user holding the handle sections on the first handle cover and the second handle cover with both hands, pressing the massage head on massage parts for extrusion massage;

c, scraping: taking off the massage head after completing massage, embedding the scraping head in the top of the connecting seat, secured by the connecting rod, the user holding the handle sections with both hands, aligning the scraping head and with massage parts for scraping;

d, moxibustion physiotherapy: after scraping, taking off the scraping head, embedding the moxibustion head in the top of the connecting seat, secured by the connecting rod, inserting an lit end of the burning moxibustion stick in the moxibustion head, the user holding the handle sections with both hands, aligning the moxibustion head with the scraping parts for moxibustion physiotherapy, and observing through the imaging assembly simultaneously.

Preferably, in steps b to d, massage, scraping and moxibustion physiotherapy aim at each part of a body in front and back. In step b and step c, manners of massage and scraping include a leaning-pressing type and a positioning type, the leaning-pressing type is leaning the back of the sleeve casing against a support flat surface, and pressing the massage head and the scraping head by a body weight to rub back and forth for massage and scraping, the positioning type is pressing the massage head and the scraping head manually to rub back and forth for completion of massage and scraping with the positioning bars as fixed fulcrums and the massage head as well as the scraping head as dynamic fulcrums. Massage time in step b is 5-10 minutes for pre-cycling blood in the massage parts. Scraping time in step c is 5-10 minutes for dissipating blood stasis. In the step d, when a moxibustion physiotherapy part is the back, a physiotherapy process is observed through the imaging assembly, time for moxibustion physiotherapy is 5-20 minutes.

Advantageous effects of the disclosure include advantages of the Chinese patent application No. 201410052231.7 and entitled “Massage device” filed on Feb. 17, 2014 applied by the applicant: a, the structure is simple, usage is convenient and flexible, massage on various sections on the body is achieved by holding different sections of the handles and bending the handles inward and outward, a single person can massage the back, neck, thighs, waist, belly, etc. with high accuracy, certain parts of the body can be massaged for a long time; b, the volume is small, weight is light, as well as portable, massage can be manual or electric on various occasions with strong applicability; c, manual massage consumes little energy, only the massage head needs to be drove to vibrate during electric massage, so that energy consumption and costs are low; d, the back of the sleeve casing is leaned against a wall or other flat surfaces during massage by design of the enclosed flat surface of the back of the sleeve casing, the massage can be long by relying on the external force in a form of holding the handles with both hands, whose massage strength is high as well as stable.

Meanwhile, the disclosure adds the scraping and moxibustion physiotherapy functions by assembling the massage head, the scraping head and the moxibustion head detachably, the massage, scraping and moxibustion physiotherapy functions can be utilized independently or altogether, a single person can complete the physiotherapy on each part in front and back of the body during massage, scraping and moxibustion physiotherapy. In the experiment, massage is firstly pre pressing and kneading physiotherapy parts to accelerate local blood circulation and dilate capillaries of skin surface, massaging and preparing for scraping simultaneously. Scraping is processed after massage, blood that has been accelerated by pre-cycling and dilated capillaries can assist to relax muscles. The moxibustion physiotherapy is finally processed, blood circulation is accelerated after massage and scraping, medicine can be transported to internal organs smoothly for regulating blood, strengthening the body and eliminating pathogenic factors, adjusting physiological functions, improving immunity, the physiotherapy has better effects within a short course.

Furthermore, the disclosure also adds positioning bars on the top of the sleeve casing, so that usage methods of the disclosure can be completing massage, scraping or moxibustion physiotherapy by leaning the sleeve casing with the positioning bars as fix fulcrums, as well as the massage head, the scraping head or the moxibustion head as dynamic fulcrums besides massage by leaning the back of the sleeve casing against the support flat surface tightly, so that the massage, scraping and moxibustion physiotherapy can be processed smoothly. Actions of massage, scraping and moxibustion physiotherapy can be observed in real time by disposing the imaging assembly when a single person treats the back with physiotherapy. A blocking plate is further disposed, a positioning groove and moxa stick holes are defined in the blocking plate, the positioning groove can be configured to position a plate shaped scraping head, and applied as an exhaust vent during moxibustion physiotherapy, and the moxa stick holes are configured to position the moxa sticks during moxibustion physiotherapy, so that the amount of the moxa sticks utilized simultaneously can be one or more than two.

### BRIEF DESCRIPTION OF THE DRAWINGS

FIG. 1 is a top view of the disclosure.

FIG. 2 is a structural schematic view of an elastic support assembly of the disclosure.

FIG. 3 is a structural schematic view of a housing assembly of the disclosure.

FIG. 4 is a structural schematic view of a massage head of the disclosure.

FIG. 5 is a lateral view of FIG. 4.

FIG. 6 is a schematic, cross-sectional view of FIG. 4 taken along A-A.

FIG. 7 is a structural schematic view of a scraping head of the disclosure.

FIG. 8 is a lateral view of FIG. 7.

FIG. 9 is a schematic, cross-sectional view of FIG. 8 taken along B-B.

FIG. 10 is a structural schematic view of a moxibustion head of the disclosure.

FIG. 11 is a lateral view of FIG. 10.

FIG. 12 is a schematic, cross-sectional view of FIG. 11 taken along C-C.

FIG. 13 is a structural schematic view of a moxa stick push assembly of the disclosure.

FIG. 14 is an assembling structural schematic view of a first embodiment of the disclosure.

FIG. 15 is one of perspective structural schematic views of an elastic support assembly according to the first embodiment of the disclosure.

FIG. 16 is the other of the perspective structural schematic views of the elastic support assembly according to the first embodiment of the disclosure.

FIG. 17 is a perspective structural schematic view of the first embodiment of the disclosure.

FIG. 18 is a top view of the first embodiment of the disclosure.

FIG. 19 is a lateral view of assembling a massage head according to the first embodiment of the disclosure.

FIG. 20 is a lateral view of assembling a scraping head according to the first embodiment of the disclosure.

FIG. 21 is a lateral view of assembling a moxibustion head according to the first embodiment of the disclosure.

FIG. 22 is a structural schematic view of assembling the massage head according to the first embodiment of the disclosure.

FIG. 23 is a structural schematic view of assembling the scraping head according to the first embodiment of the disclosure.

FIG. 24 is a structural schematic view of assembling the moxibustion head according to the first embodiment of the disclosure.

FIG. 25 is a perspective structural schematic view of the massage head according to the first embodiment of the disclosure.

FIG. 26 is a perspective structural schematic view of the scraping head according to the first embodiment of the disclosure.

FIG. 27 is a perspective structural schematic view of the moxibustion head according to the first embodiment of the disclosure.

FIG. 28 is a disassembled structural schematic view of another embodiment of the disclosure.

FIG. 29 is a schematic view of assembling a massage head in FIG. 28.

FIG. 30 is a schematic view of assembling a scraping head in FIG. 28.

### DETAILED DESCRIPTION OF PREFERRED EMBODIMENTS

The disclosure will be further described with reference to the accompanying drawings as follows.

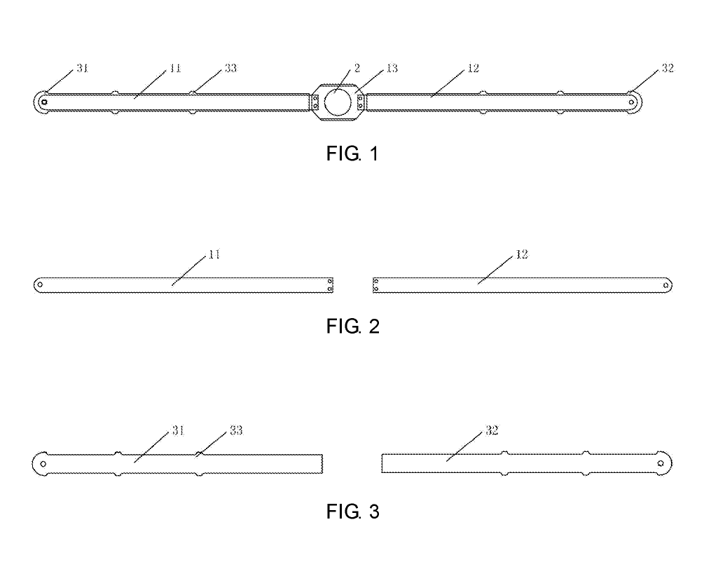

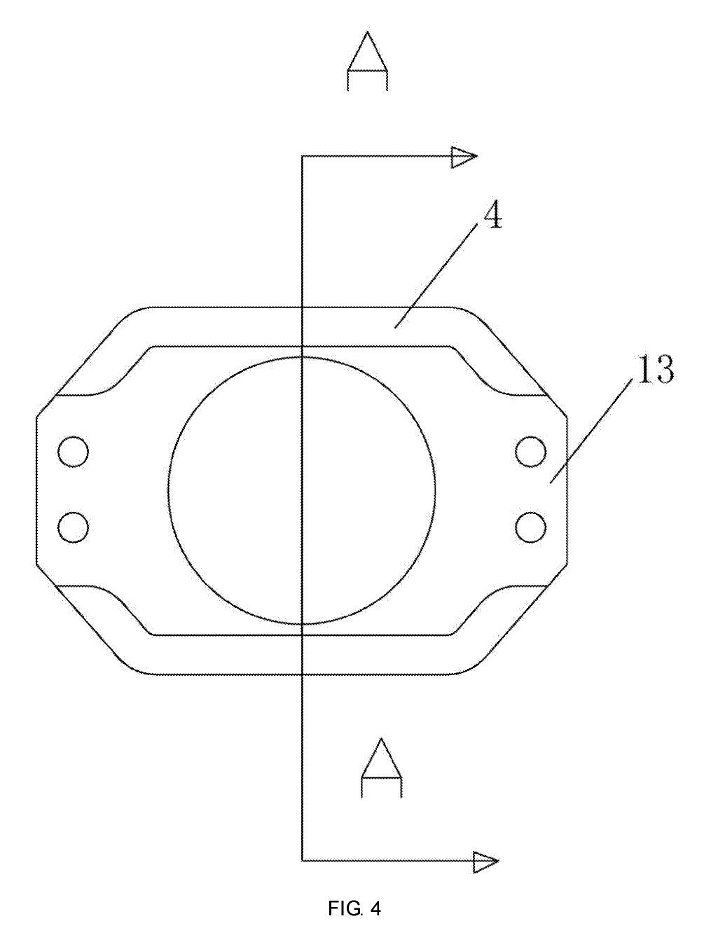

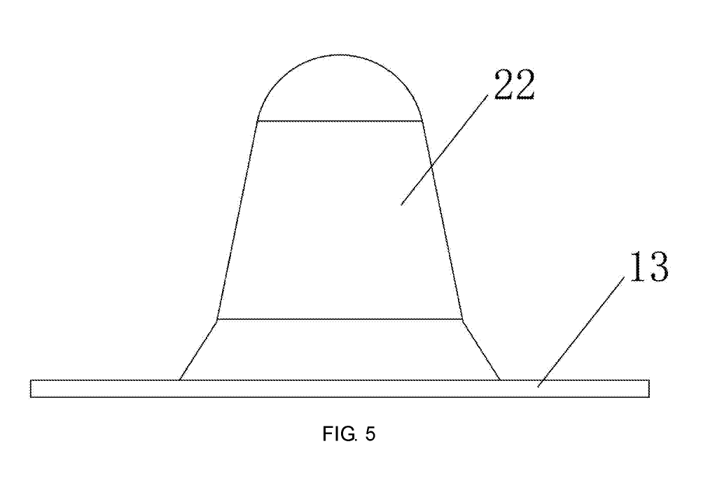

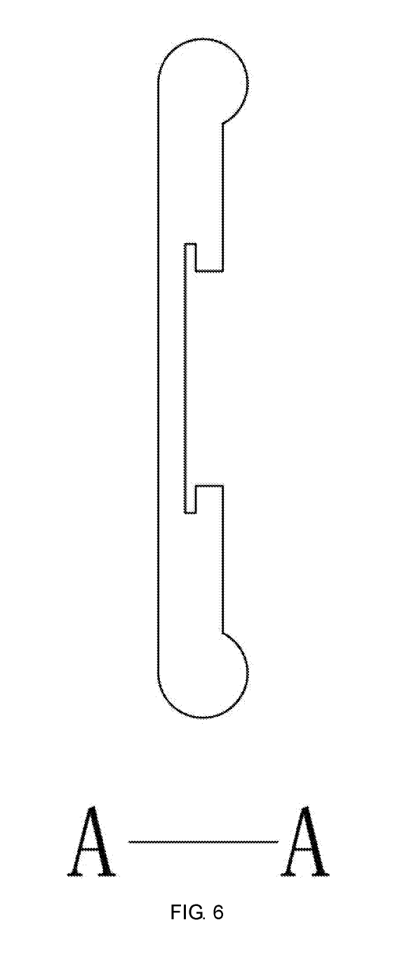

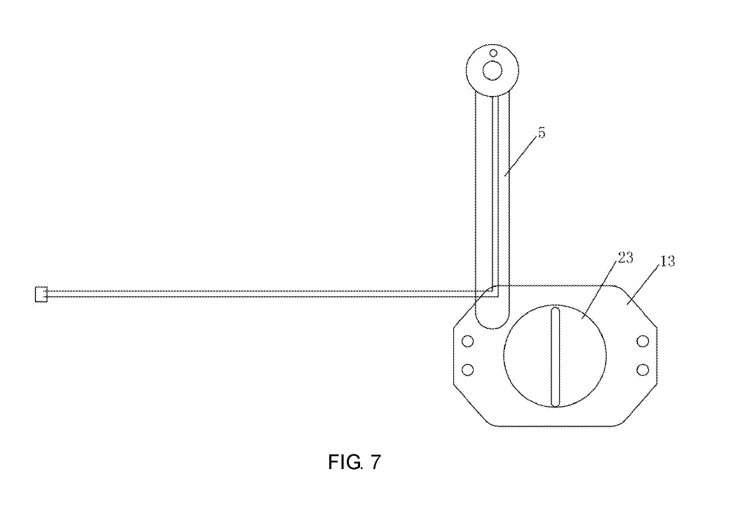

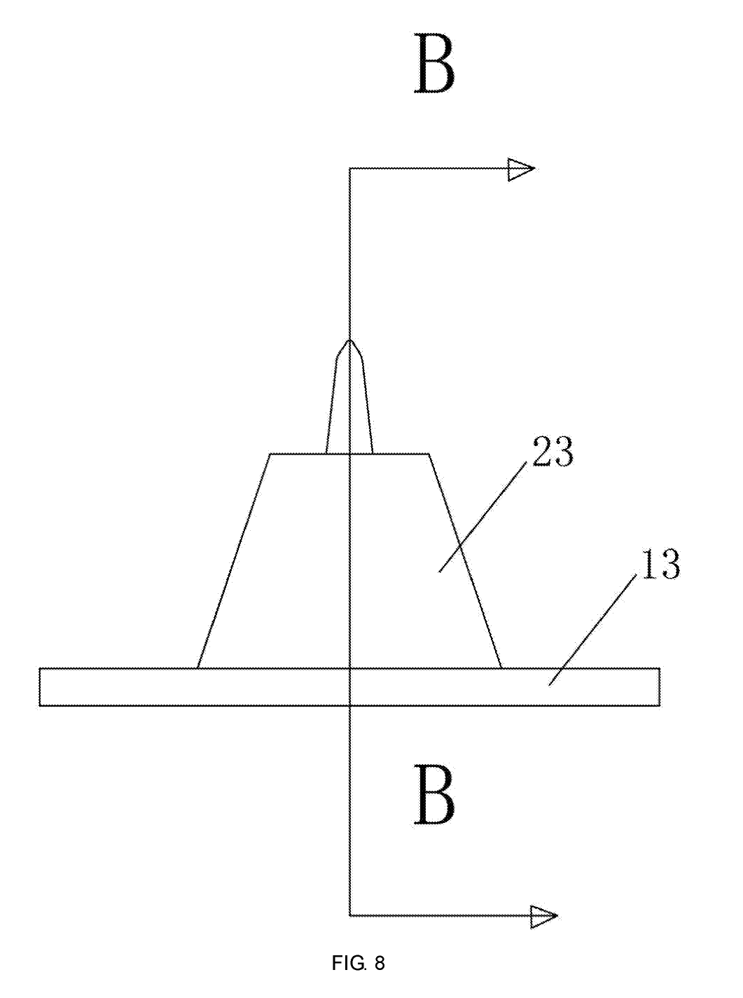

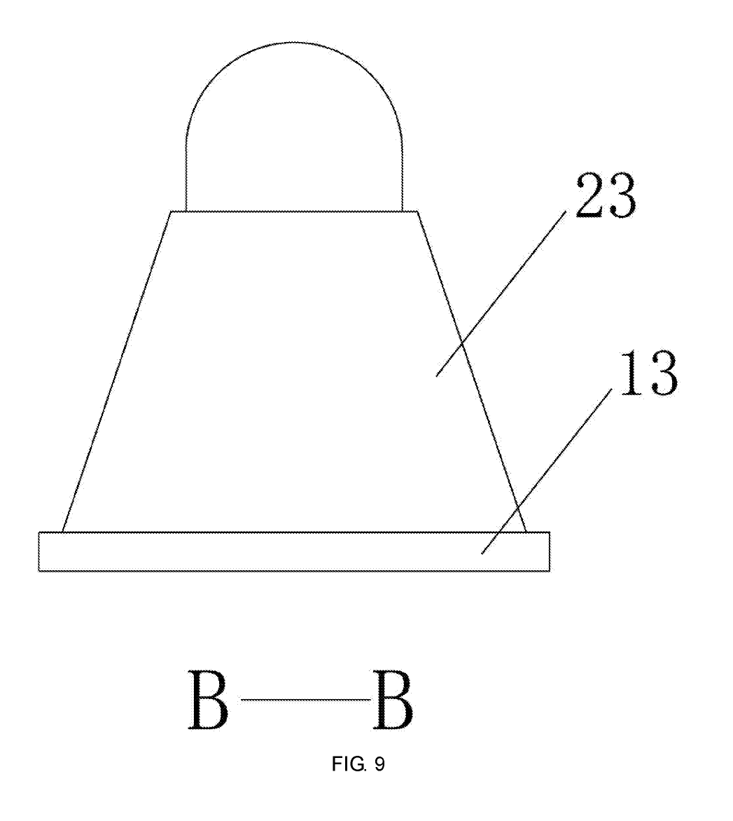

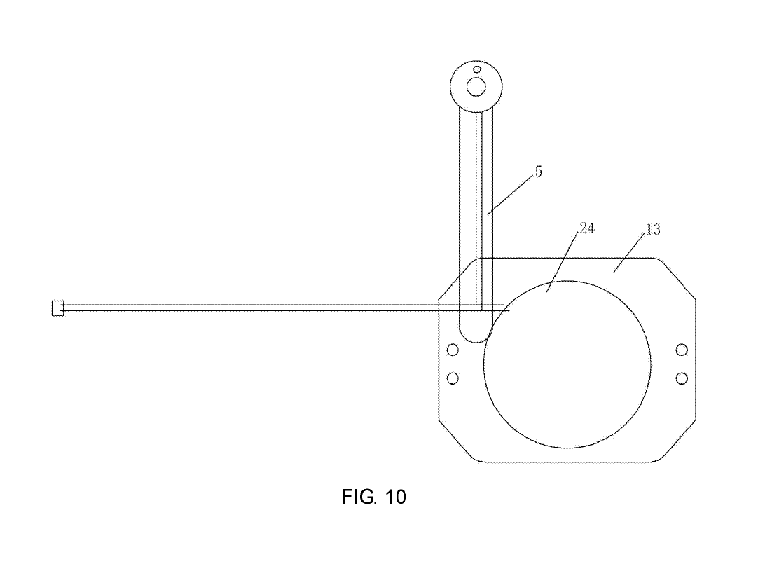

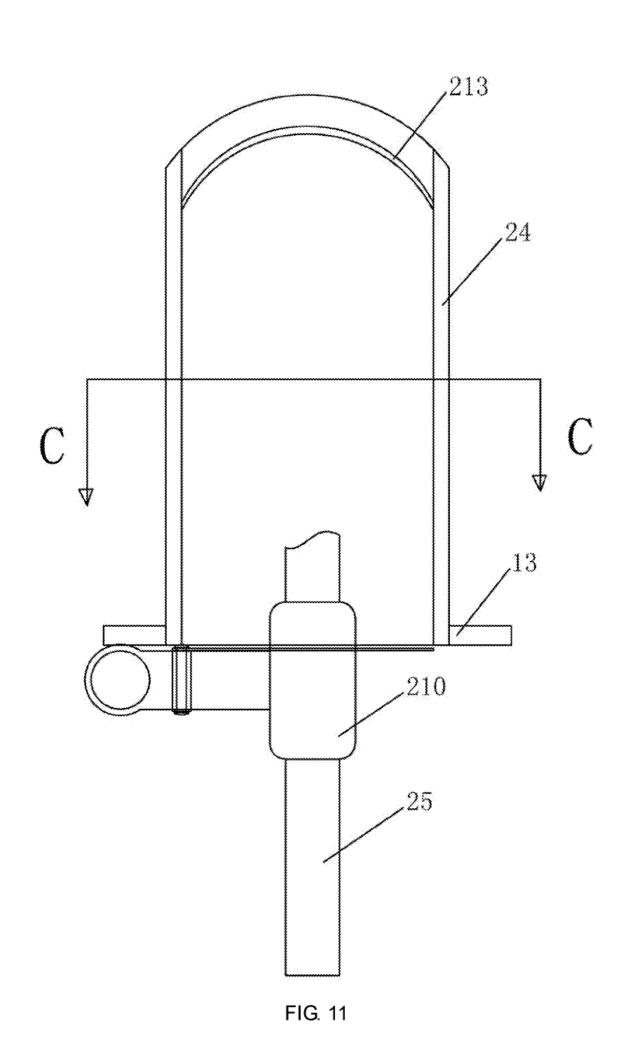

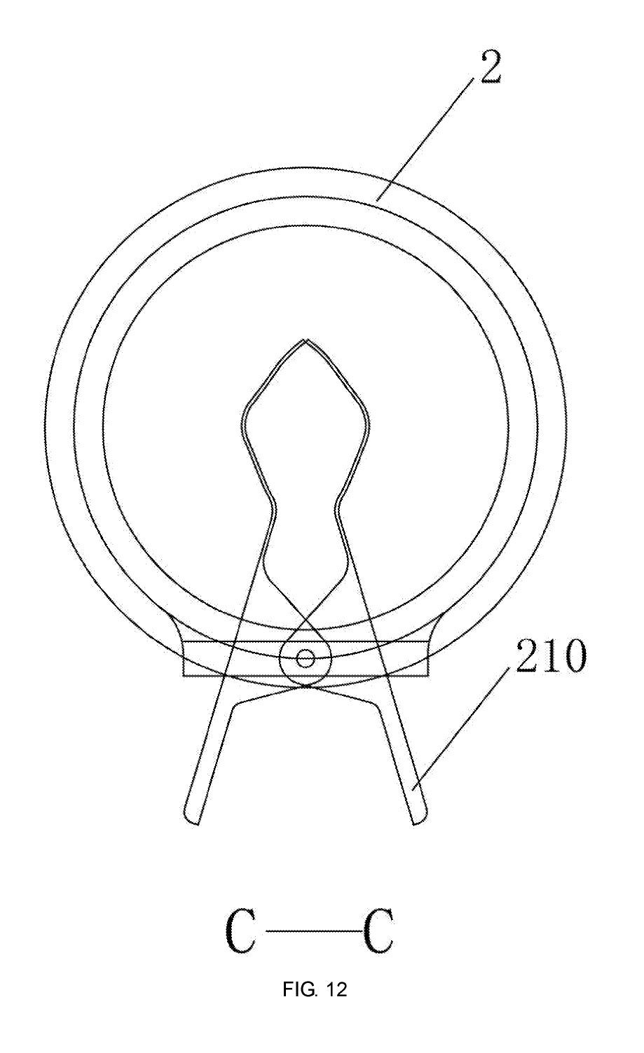

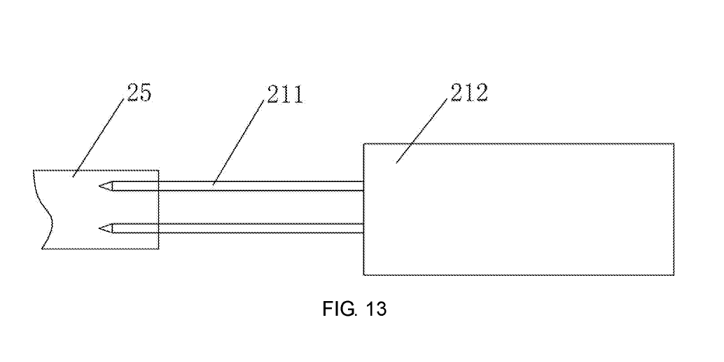

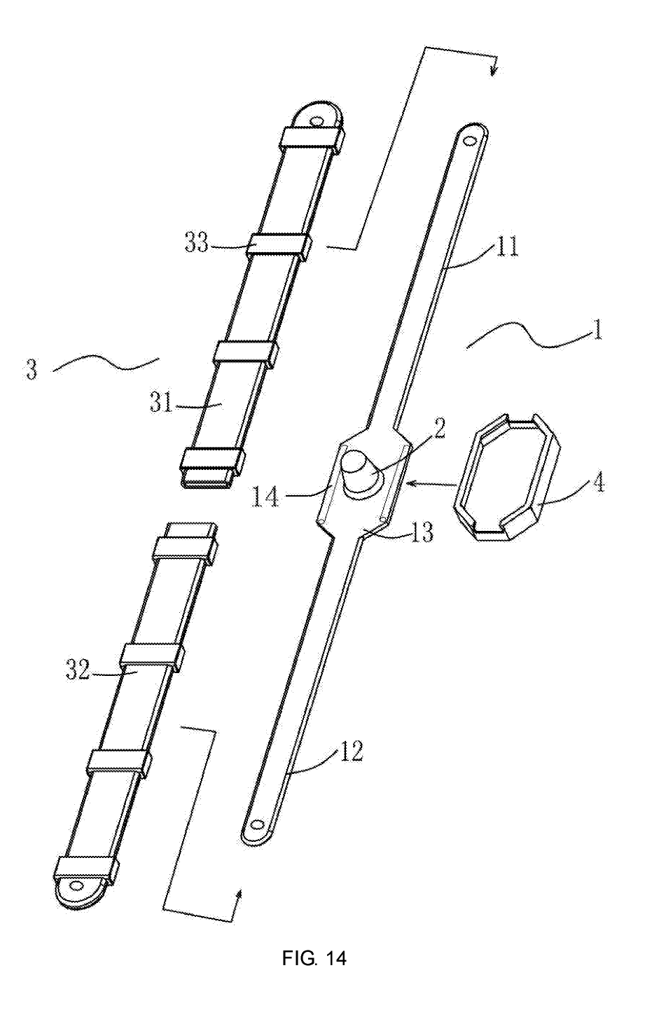

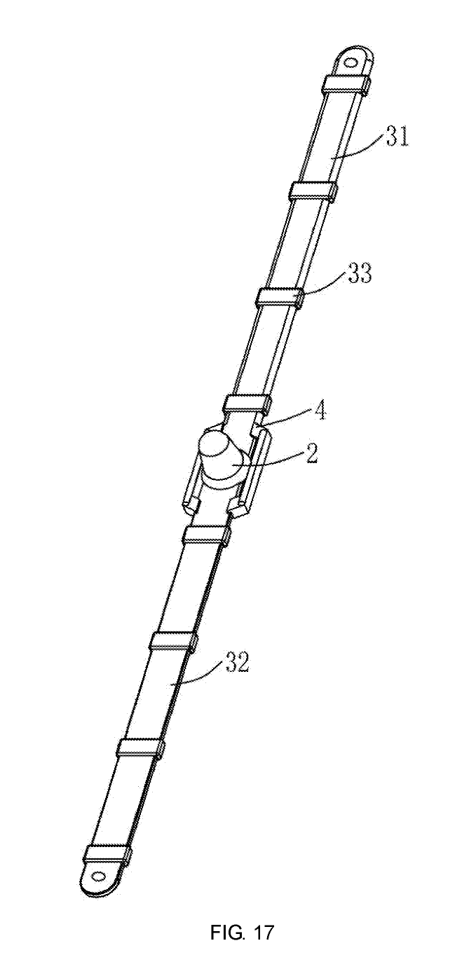

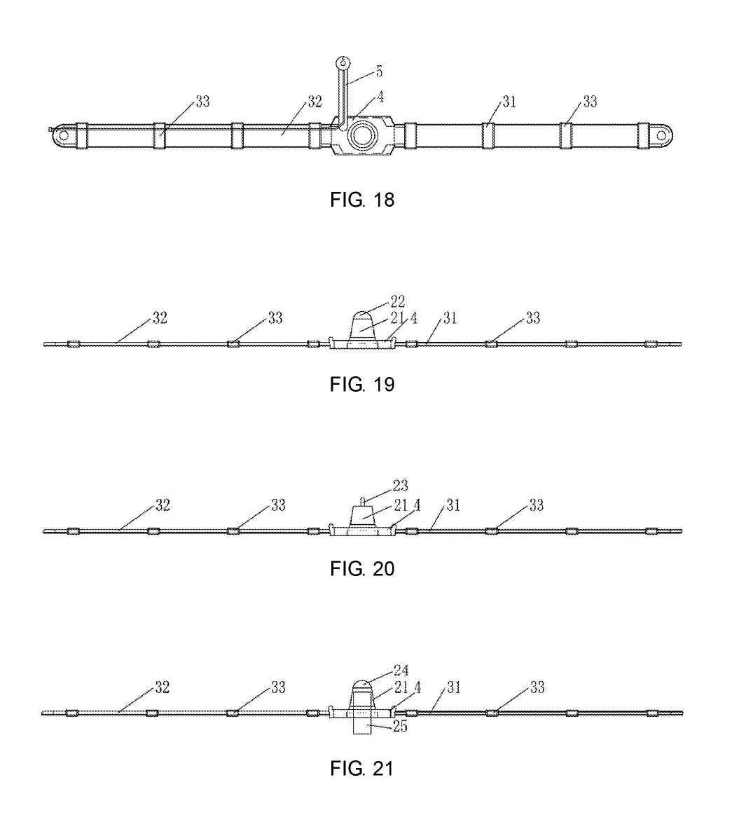

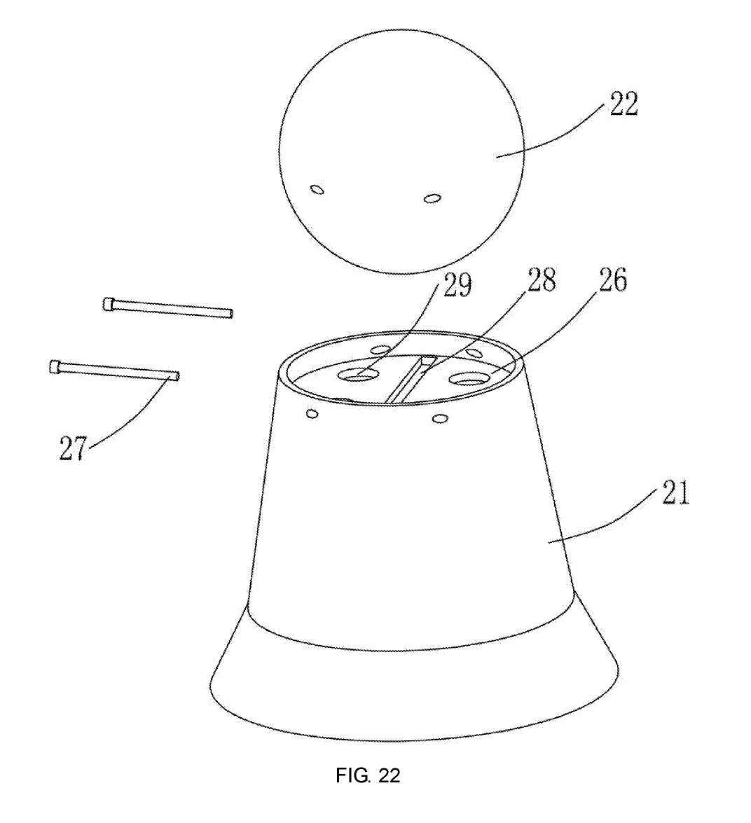

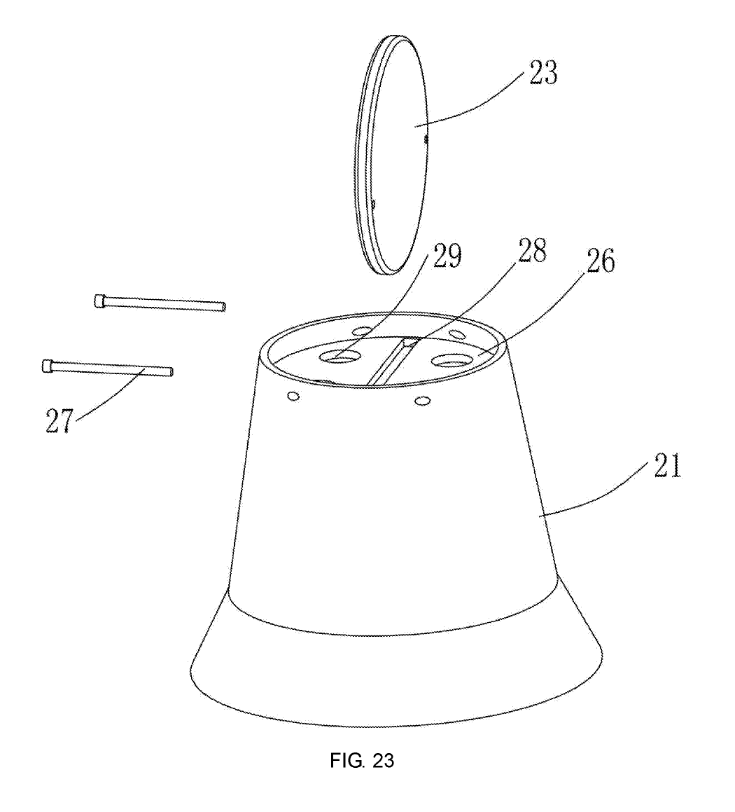

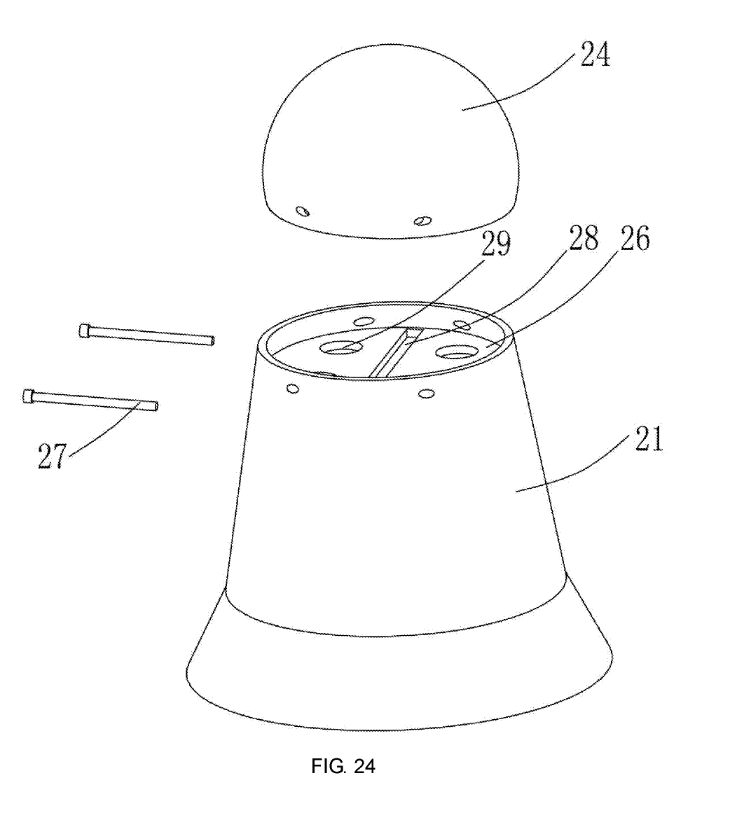

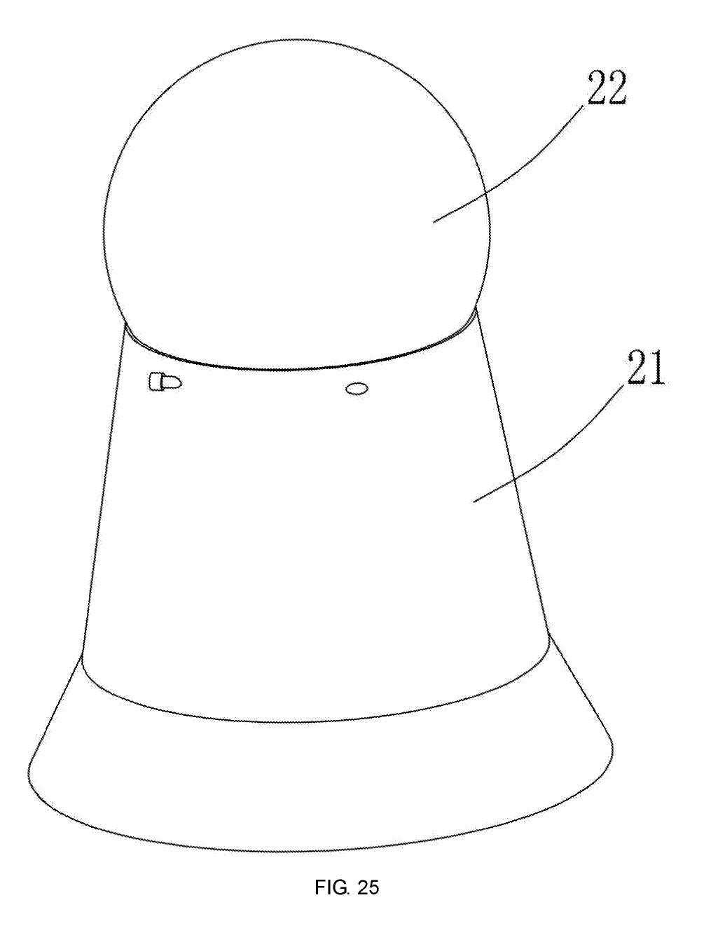

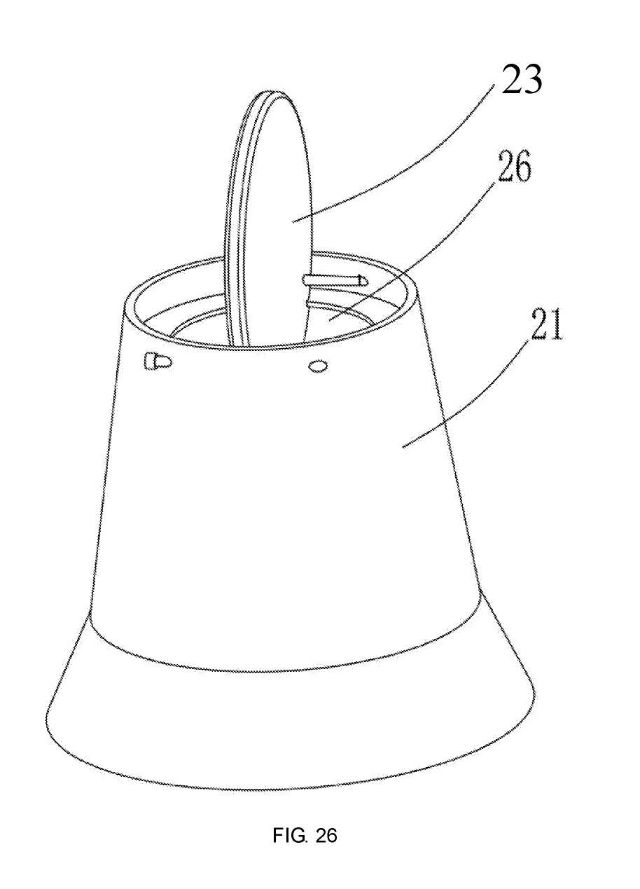

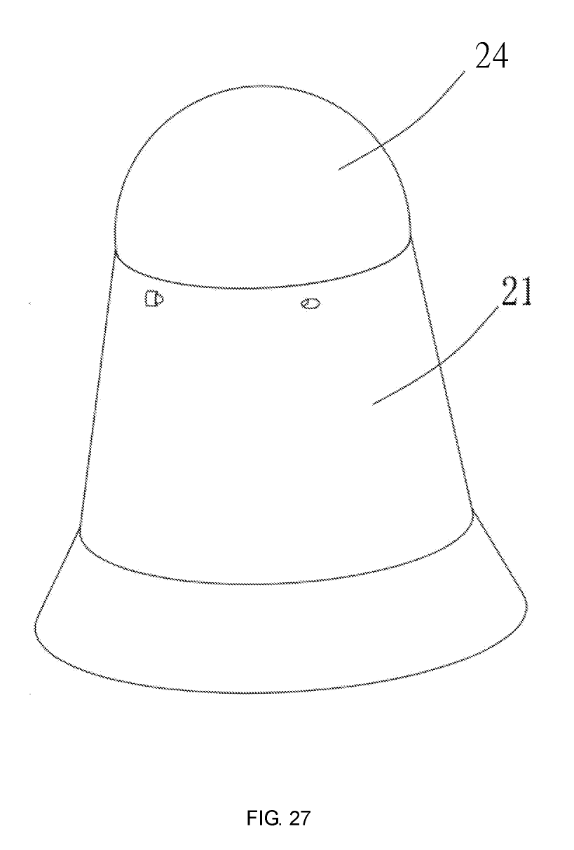

A first embodiment is shown as FIG. 1 to FIG. 27, the disclosure is as follows. A multifunctional physiotherapy device includes an elastic support assembly 1, a physiotherapy assembly 2, a housing assembly 3, a sleeve casing 4 and an imaging assembly 5. The housing assembly 3 is disposed out of the elastic support assembly 1, the physiotherapy assembly 2 is detachably secured on the elastic support assembly 1. The sleeve casing 4 is disposed at a joint of the physiotherapy assembly 2 and the elastic support assembly 1. A user holds the housing assembly 3 to align the physiotherapy assembly with a physiotherapy area and moves it back and forth to complete the physiotherapy, and observes physiotherapy actions through the imaging assembly 5. The physiotherapy assembly 2 includes a massage head 22, a scraping head 23 and a moxibustion head 24, the massage head 22, the scraping head 23 and the moxibustion head 24 are all detachably secured on the elastic support assembly 1 for completing massage, scraping and moxibustion physiotherapy actions respectively.

Preferably, the elastic support assembly 1 includes a first handle 11, a second handle 12 and a connecting plate 13. The first handle 11 and the second handle 12 are flexible handles, internal ends of which are secured on two ends of the connecting plate 13 respectively. Two sides of the connecting plate 13 are disposed with positioning bars 14 whose diameter is in a range of 4-20 mm, the positioning bars 14 play a positioning role during physiotherapy or pat and massage directly.

Preferably, the housing assembly 3 includes a first handle cover 31, a second handle cover 32 and spacer rings 33. The first handle cover 31 and the second handle cover 32 are flexible handle covers wrapping the first handle 11 and the second handle 12 respectively. At least two spacer rings 33 are disposed around the first handle 31 and the second handle 32 separately, the spacer rings 33 divide the first handle cover 31 and the second handle cover 32 into at least two sections longitudinally. The sections are handle sections, the handle sections of different distances are for various massage parts.

Preferably, the sleeve casing 4 wraps the connecting plate 13 and the positioning bars 14 for providing buffer during pat and massage. A bottom of the sleeve casing 4 is an enclosed flat surface for bearing stress, preventing slip and protecting a surface of a pressed objective. A top and two ends of the sleeve casing 4 are open, the physiotherapy assembly 2 extends through the top of the sleeve casing 4, the first handle cover 31 and the second handle cover 32 extend through the two ends of the sleeve casing 4 respectively, external surfaces of which and an internal surface of the sleeve casing 4 are interference connected.

Preferably, thicknesses of the first handle 11 and the second handle 12 are 0.3-2.5 mm, widths of which are 15-45 mm, material is flaky elastic material. Holes with a diameter in a range of 6-12 mm are defined in two ends of the first handle 11 and the second handle 12 respectively for hanging and packaging.

Preferably, a mesh plate 213 is disposed in the moxibustion head 24 to collect ashes after burning a moxa stick. A bottom of the moxibustion head 24 is secured with a moxa stick clamp 210, a clamp opening of the moxa stick clamp 210 clips a moxibustion stick 25 for fixing and positioning. The moxibustion stick 25 is pushed inwards the moxibustion head 24 by releasing the clamp opening after burning the moxibustion stick 25 for a while.

Preferably, a moxa stick push assembly is inserted in a tail of the moxibustion stick 25. The moxa stick push assembly includes a push pin 211 and a push pin seat 212, the push pin 211 is inserted in the tail of the moxibustion stick 25. The push pin seat 212 is pushed forward to burn the remaining moxibustion stick 25 when the moxibustion stick 25 is about to be burnt out.

Preferably, the physiotherapy assembly 2 further includes a connecting seat 21, the connecting seat 21 is secured on the connecting plate 13. The massage head 22, the scraping head 23 and the moxibustion head 24 are all detachably secured on the connecting seat 21. A through-hole is defined in the middle of the connecting seat 21, a blocking plate 26 is disposed in the through-hole adjacently to its upper end, a positioning groove 28 and at least two moxa stick holes 29 are defined in the blocking plate 26, the moxibustion head 23 is embedded in the positioning groove 28 for positioning, one or at least two moxibustion sticks 25 are inserted in the moxa stick holes 29 for fixing. Connecting holes are defined in two sides of the connecting seat 21, connecting holes are further defined in the massage head 22, the scraping head 23 and the moxibustion head 24 correspondingly, the massage head 22, the scraping head 23 and the moxibustion head 24 are embedded in a top of the connecting seat 21 respectively, a connecting rod 27 is inserted in the connecting holes of connecting seat 21, the massage head 22, the scraping head 23 and the moxibustion head 24 respectively and detachably securing the massage head 22, the scraping head 23 and the moxibustion head 24 on the connecting seat 21 respectively.

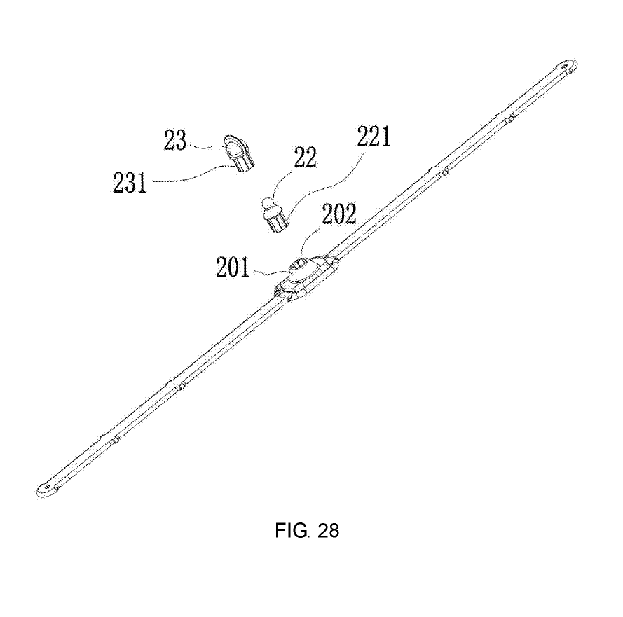

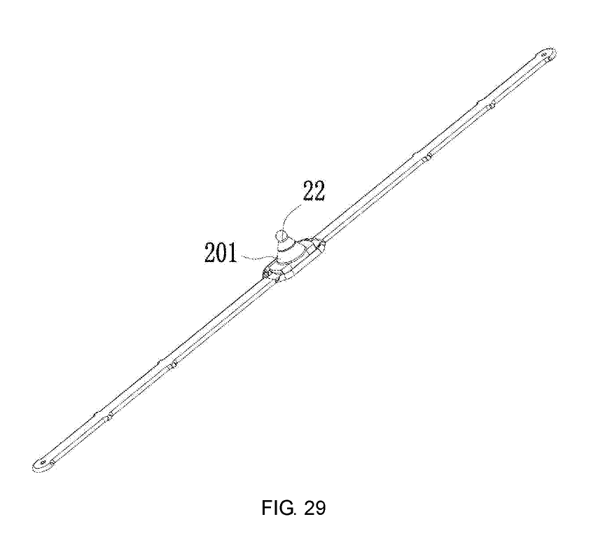

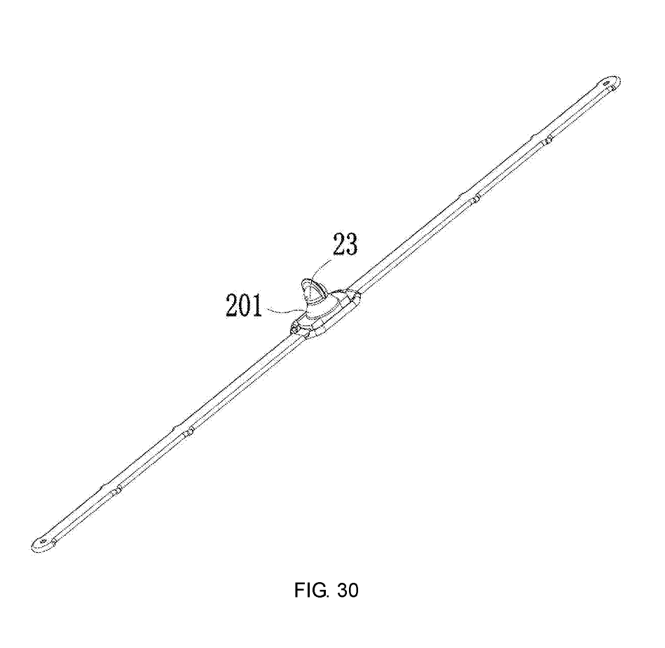

Preferably, as shown in FIG. 28-30, the physiotherapy assembly 2 includes a positioning seat 201, a hole slotting 202 is defined in the positioning seat 201, a bottom of the massage head 22 is disposed with a column 221, the column 221 of the massage head 22 is capable of being inserted in the hole slotting 202 to position the massage head 22 on the positioning seat 201. A bottom of the scraping head 23 is further disposed with a column 231, the column 231 of the scraping head 23 is capable of being inserted in the hole slotting 202 to position the scraping head 23 on the positioning seat 201. Moreover, the columns 221, 231 of the massage head 22 and the scraping head 23 are disposed with magnets, a bottom of the hole slotting 202 is disposed with a piece of iron, so that the bottoms of the massage head 22 and the scraping head 23 are capable of holding the piece of iron by the magnets.

A physiotherapy method utilizing the multifunctional physiotherapy device above includes following steps:

a, assembling: first, placing the first handle 11 and the second handle 12 in the first handle cover 31 and the second handle cover 32 respectively, second, covering the sleeve casing 4 on the first handle cover 31, the second handle cover 32 and the connecting plate 13, finally, securing the connecting seat 21 on the connecting plate 13;

b, massage: embedding the massage head 22 in the top of the connecting seat 21, fixing and positioning by the connecting rod 27, a user holding the handle sections on the first handle cover 31 and the second handle cover 32 with both hands, pressing the massage head 22 on massage parts for extrusion massage;

c, scraping: taking off the massage head 22 after completing massage, embedding the scraping head 23 in the top of the connecting seat 21, secured by the connecting rod 27, the user holding the handle sections with both hands, aligning the scraping head with the massage parts for scraping;

d, moxibustion physiotherapy: after scraping, taking off the scraping head 23, embedding the moxibustion head 24 in the top of the connecting seat 21, secured by the connecting rod 27, inserting an lit end of the burning moxibustion stick 25 in the moxibustion head 24, the user holding the handle sections with both hands, aligning the moxibustion head 24 with the scraping parts for moxibustion physiotherapy, and observing through the imaging assembly 5 simultaneously.

Preferably, in steps b to d, massage, scraping and moxibustion physiotherapy aim at each part of a body in front and back. In step b and step c, manners of massage and scraping include a leaning-pressing type and a positioning type, the leaning-pressing type is leaning the back of the sleeve casing 4 against a support flat surface, and pressing the massage head 22 and the scraping head 23 by a body weight to rub back and forth for massage and scraping, the positioning type is pressing the massage head 22 and the scraping head 23 manually to rub back and forth for completion of massage and scraping with the positioning bars 14 as fixed fulcrums and the massage head 22 as well as the scraping head 23 as dynamic fulcrums. Massage time in step b is 5-10 minutes for pre-cycling blood in the massage parts. Scraping time in step c is 5-10 minutes for dissipating blood stasis. In the step d, when a moxibustion physiotherapy part is the back, a physiotherapy process is observed through the imaging assembly 5, time for moxibustion physiotherapy is 5-20 minutes.

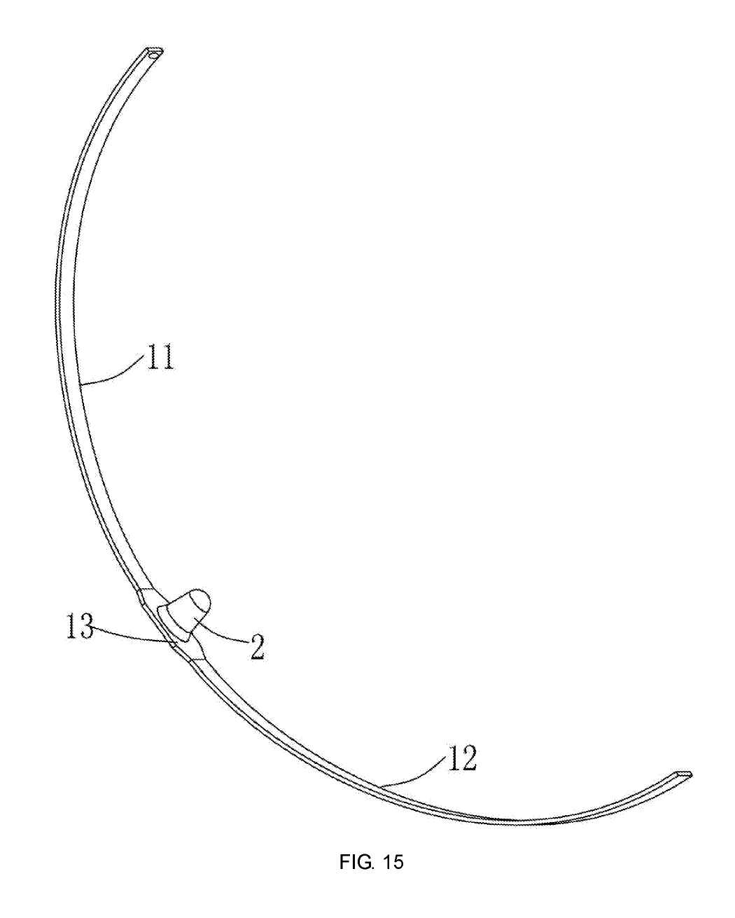

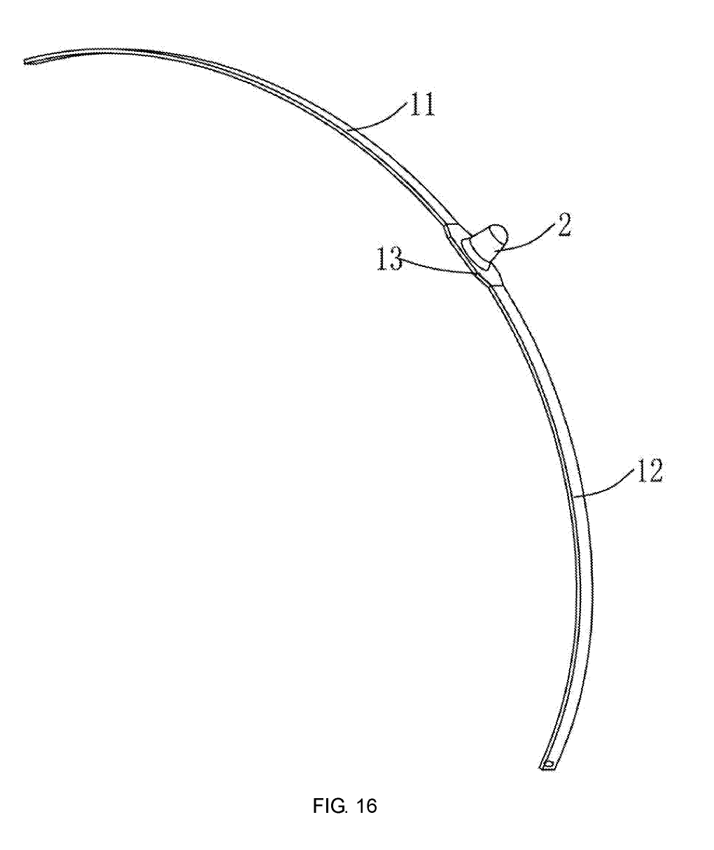

Furthermore, the disclosure includes multiple use states, as shown in FIG. 15, the first handle 11 and the second handle 12 are bent inwards, a user holds two ends of the first handle 11 and the second handle 12 respectively with each hand to align the physiotherapy assembly 2 with a rear section such as the neck, back or waist for massage. The back of the connecting plate 13 is leant against the wall tightly, the body presses the physiotherapy assembly 2, massage is processed by the force against the wall with stability, and a deep massage with long time can be processed. The massage strength can be over 40 kg, the design belongs to top in the field. As shown in FIG. 16, the first handle 11 and the second handle 12 are bent outwards, the user holds the two ends of the first handle 11 and the second handle 12 with both hands respectively, the physiotherapy assembly 2 is aligned with thighs, calves, bully, etc. to squeeze back and forth for achieving effects of massage while sit, or the massage parts are patted utilizing elasticity of handles, the massage strength and position can be adjusted by holding various sections on the handles, the spacer rings 33 around the handle covers play a role of positioning, which prevent slipping and dropping with holding the handle covers. Thicknesses of the first handle 3 and the second handle 4 are 0.3-2.5 mm, widths of which are 15-45 mm, a sum of lengths of the first handle 11 and the second handle 12 is 500-2500 mm, material is flaky elastic material. Holes with a diameter in a range of 6-12 mm are defined in two ends of the first handle 11 and the second handle 12 respectively for hanging and packaging.

Furthermore, the imaging assembly 5 includes a lens with lamplight, a lens connecting line and a connector, the lens connecting line can be mounted on the handle cover, two ends of the lens connecting line are connected to the lens and the connector respectively, the connector can be connected with a device such as a mobile phone, a computer or a projector for displaying images recorded by the lens in real time.

Furthermore, a positioning groove 28 and moxa stick holes 29 are defined in the blocking plate 26, the blocking plate 26 can support the bottom of the massage head 22 during actions of massage. The positioning groove 28 can be configured to limit the position and support the plate-shaped scraping head 23 during scraping. The top of the moxibustion head 24 is downward during moxibustion physiotherapy, the burning moxa stick 25 is inserted in the moxibustion head 24 from the connecting seat 21 through the moxa stick holes 29, smoke generated by burning the moxibustion stick 25 is exhausted through the positioning groove 28 or the moxa stick holes 29 without the moxibustion stick 25 inserted, ashes generated by inflammation fall in the moxibustion head 24, the ashes can be poured out by disassembling the moxibustion head 24, the moxa stick holes 29 are used to position moxa sticks during moxibustion physiotherapy in order to enable the amount of moxa sticks utilized simultaneously to be one or more than two.

Embodiments of the disclosure are merely illustrated embodiments, which do not limit the protection scope of the disclosure. A person skilled in the art can achieve modifications inspired by the embodiments, so that equivalent replacements and so forth according to the range of the disclosure should be covered by the protected scope of the disclosure.

### INDUSTRIAL APPLICABILITY

Industrial applicability: the disclosure is a multifunctional physiotherapy device and a physiotherapy method, the structure is simple and the design is ingeniously, a single person can use it to complete physiotherapy actions with convenience, physics and medicine are combined to provide a remarkable physiotherapy effect. Therefore, industrial applicability is contained.

What is claimed is:

1. A multifunctional physiotherapy device, comprising an elastic support assembly, a physiotherapy assembly, a housing assembly, a sleeve casing and an imaging assembly, the housing assembly wrapping the elastic support assembly, the physiotherapy assembly detachably secured on the elastic support assembly, the sleeve casing disposed at a joint of the physiotherapy assembly and the elastic support assembly; the housing assembly used to be held by a user to align the physiotherapy assembly with a physiotherapy area and move it back and forth to complete physiotherapy, the imaging assembly used to observe physiotherapy actions; the physiotherapy assembly comprising a massage head, a scraping head and a moxibustion head, the massage head, the scraping head and the moxibustion head detachably secured on the elastic support assembly, used to execute massage, scraping and moxibustion physiotherapy actions respectively; the elastic support assembly comprising a first handle, a second handle and a connecting plate, the first handle and the second handle being flexible handles, internal ends of the first handle and the second handle secured on two ends of the connecting plate respectively; two sides of the connecting plate being disposed with positioning bars, a diameter of each of the positioning bar being in a range of 4-20 mm, the positioning bars used to play a positioning role during physiotherapy or pat and massage directly; the housing assembly comprising a first handle cover, a second handle cover and spacer rings, the first handle cover and the second handle cover being flexible handle covers wrapping the first handle and the second handle respectively, at least two spacer rings being disposed around the first handle cover and the second handle cover separately, the spacer rings dividing the first handle cover and the second handle cover into at least two sections longitudinally, the sections used to be held, the handle sections of different distances used for various massage parts.

2. The multifunctional physiotherapy device according to claim 1, wherein the sleeve casing wraps the connecting plate and the positioning bars for providing buffer during pat and massage, a bottom of the sleeve casing is an enclosed flat surface for bearing stress, preventing slip and protecting a surface of a pressed objective; a top and two ends of the sleeve casing are open, the physiotherapy assembly extends through the top of the sleeve casing, the first handle cover and the second handle cover extend through the two ends of the sleeve casing respectively, external surfaces of which and an internal surface of the sleeve casing are interference connected.

3. The multifunctional physiotherapy device according to any one of claim 2, wherein thicknesses of the first handle and the second handle are 0.3-2.5 mm, widths of which are 15-45 mm, material is flaky elastic material, holes with a diameter in a range of 6-12 mm are defined in two ends of the first handle and the second handle respectively for hanging and packaging.

4. The multifunctional physiotherapy device according to claim 3, wherein a mesh plate is disposed in the moxibustion head to collect ashes after burning a moxa stick; a bottom of the moxibustion head is secured with a moxa stick clamp, a clamp opening of the moxa stick clamp clips a moxibustion stick for fixing and positioning, the moxibustion stick is pushed inwards the moxibustion head by releasing the clamp opening after burning the moxibustion stick for a while.

5. The multifunctional physiotherapy device according to claim 4, wherein a moxa stick push assembly is inserted in a tail of the moxibustion stick, the moxa stick push assembly comprises a push pin and a push pin seat, the push pin is inserted in the tail of the moxibustion stick, the push pin seat is pushed forward for burning the remaining moxibustion stick when the moxibustion stick is about to be burnt out.

6. The multifunctional physiotherapy device according to claim 5, wherein the physiotherapy assembly further comprises a connecting seat and a connecting rod, the connecting seat is secured on the connecting plate; the massage head, the scraping head and the moxibustion head are detachably secured on the connecting seat, a through-hole is defined in the middle of the connecting seat, a blocking plate is disposed in the through-hole adjacently to its upper end, a positioning groove and at least two moxa stick holes are defined in the blocking plate, the scraping head is embedded in the positioning groove for positioning, one or at least two moxibustion sticks are inserted in the moxa stick holes for fixing; connecting holes are defined in two sides of the connecting seat, connecting holes are further defined in the massage head, the scraping head and the moxibustion head correspondingly, the massage head, the scraping head and the moxibustion head are embedded in a top of the connecting seat respectively, the connecting rod is inserted in the connecting holes of connecting seat, the massage head, the scraping head and the moxibustion head respectively and detachably securing the massage head, the scraping head and the moxibustion head on the connecting seat respectively.

7. The multifunctional physiotherapy device according to claim 1, wherein thicknesses of the first handle and the second handle are 0.3-2.5 mm, widths of which are 15-45 mm, material is flaky elastic material, holes with a diameter in a range of 6-12 mm are defined in two ends of the first handle and the second handle respectively for hanging and packaging.

8. The multifunctional physiotherapy device according to claim 7, wherein a mesh plate is disposed in the moxibustion head to collect ashes after burning a moxa stick; a bottom of the moxibustion head is secured with a moxa stick clamp, a clamp opening of the moxa stick clamp clips a moxibustion stick for fixing and positioning, the moxibustion stick is pushed inwards the moxibustion head by releasing the clamp opening after burning the moxibustion stick for a while.

9. The multifunctional physiotherapy device according to claim 8, wherein a moxa stick push assembly is inserted in a tail of the moxibustion stick, the moxa stick push assembly comprises a push pin and a push pin seat, the push pin is inserted in the tail of the moxibustion stick, the push pin seat is pushed forward for burning the remaining moxibustion stick when the moxibustion stick is about to be burnt out.

10. The multifunctional physiotherapy device according to claim 9, wherein the physiotherapy assembly further comprises a connecting seat and a connecting rod, the connecting seat is secured on the connecting plate; the massage head, the scraping head and the moxibustion head are detachably secured on the connecting seat, a through-hole is defined in the middle of the connecting seat, a blocking plate is disposed in the through-hole adjacently to its upper end, a positioning groove and at least two moxa stick holes are defined in the blocking plate, the scraping head is embedded in the positioning groove for positioning, one or at least two moxibustion sticks are inserted in the moxa stick holes for fixing; connecting holes are defined in two sides of the connecting seat, connecting holes are further defined in the massage head, the scraping head and the moxibustion head correspondingly, the massage head, the scraping head and the moxibustion head are embedded in a top of the connecting seat respectively, the connecting rod is inserted in the connecting holes of connecting seat, the massage head, the scraping head and the moxibustion head respectively and detachably securing the massage head, the scraping head and the moxibustion head on the connecting seat respectively.

11. The multifunctional physiotherapy device according to claim 1, wherein the imaging assembly has a wireless connection module to connect the imaging assembly with an external electric display device wirelessly, and display physiotherapy actions by the external electric display device.

12. The multifunctional physiotherapy device according to claim 11, wherein the wireless connection module is a wireless Bluetooth module or a wireless WIFI module.

13. The multifunctional physiotherapy device according to claim 1, wherein the physiotherapy assembly comprises a positioning seat, a hole slotting is defined in the positioning seat, a bottom of the massage head is disposed with a column, the column of the massage head is capable of being inserted in the hole slotting to position the massage head on the positioning seat; a bottom of the scraping head is further disposed with a column, the column of the scraping head is capable of being inserted in the hole slotting to position the scraping head on the positioning seat.

14. The multifunctional physiotherapy device according to claim 13, wherein the columns of the massage head and the scraping head are disposed with magnets, a bottom of the hole slotting is disposed with a piece of iron, so that the bottoms of the massage head and the scraping head are capable of holding the piece of iron by the magnets.

15. A physiotherapy method utilizing the multifunctional physiotherapy device according to claim 1, comprising following steps:
a, assembling: first, placing the first handle and the second handle in the first handle cover and the second handle cover respectively, second, covering the sleeve casing on outsides of the first handle cover, the second handle cover and the connecting plate, finally, securing the connecting seat on the connecting plate;
b, massage: embedding the massage head in the top of the connecting seat, and fixing and positioning by the connecting rod, a user holding the handle sections on the first handle cover and the second handle cover with both hands, pressing the massage head on massage parts for extrusion massage;
c, scraping: taking off the massage head after completing massage, embedding the scraping head in the top of the connecting seat, secured by the connecting rod, the user holding the handle sections with both hands, aligning the scraping head with the massage parts for scraping;
d, moxibustion physiotherapy: after scraping, taking off the scraping head, embedding the moxibustion head in the top of the connecting seat, secured by the connecting rod, inserting an lit end of the burning moxibustion stick in the moxibustion head, the user holding the handle sections with both hands, aligning the moxibustion head with the scraping parts for moxibustion physiotherapy, and observing through the imaging assembly simultaneously.

16. The physiotherapy method according to claim 15, wherein in the steps b to d, massage, scraping and moxibustion physiotherapy aim at each part of a body in front and back; in step b and step c, manners of massage and scraping comprise a leaning-pressing type and a positioning type, the leaning-pressing type is leaning the back of the sleeve casing against a support flat surface, and pressing the massage head and the scraping head by a body weight to rub back and forth for massage and scraping, the positioning type is pressing the massage head and the scraping head manually to rub back and forth for completion of massage and scraping with the positioning bars as fixed fulcrums and the massage head as well as the scraping head as dynamic fulcrums; massage time in step b is 5-10 minutes for pre-cycling blood in the massage parts; scraping time in step c is 5-10 minutes for dissipating blood stasis; in the step d, when a moxibustion physiotherapy part is the back, a physiotherapy process is observed through the imaging assembly, time for moxibustion physiotherapy is 5-20 minutes.
